(19) United States
(12) Patent Application Publication
(10) Pub. No.: US 2015/0200563 A1
(43) Pub. Date: Jul. 16, 2015

(54) TRANSMITTING DEVICE, WIRELESS CHARGING SYSTEM COMPRISING TRANSMITTING DEVICE, AND METHOD FOR CONTROLLING CHARGING PROCESS THEREOF

(71) Applicant: Shenzhen BYD Auto R&D Company Limited, Shenzhen (CN)

(72) Inventors: Xinhua Zhang, Shenzhen (CN); He Huang, Shenzhen (CN); Ying Zhou, Shenzhen (CN); Qingchun Yang, Shenzhen (CN); Xinwei Cai, Shenzhen (CN); Zaixing Yang, Shenzhen (CN); Dajun Chen, Shenzhen (CN)

(21) Appl. No.: 14/550,799

(22) Filed: Nov. 21, 2014

Related U.S. Application Data
(63) Continuation of application No. PCT/CN2013/075723, filed on May 16, 2013.

(30) Foreign Application Priority Data
Jun. 4, 2012 (CN) 201210180427.5
Jun. 4, 2012 (CN) 201220259100.2

(51) Int. Cl. H02J 7/02; H02J 5/00; H02J 7/00

(52) U.S. Cl. CPC H02J 7/025; H02J 7/007; H02J 5/005

(57) ABSTRACT

A transmitting device, a wireless charging system comprising the transmitting device and a method for controlling a charging process of the wireless charging system are provided. The transmitting device comprises: a transmitting coil configured to transmit an electric energy of the transmitting device; an oscillation and FM module configured to generate an LC resonance between the transmitting coil and the oscillation and FM module and to adjust a capacitance of the LC resonance so as to change a resonant frequency of the LC resonance; a first detecting module configured to detect a voltage and a current of the transmitting device; a control module configured to output a control signal to control the resonant frequency of the LC resonance according to a predetermined FM mode; a first communicating module configured to communicate with the receiving device wirelessly; and a power module configured to supply a drive power to the transmitting device.

### CROSS REFERENCE TO RELATED APPLICATIONS

This application claims the benefit of International Patent Application No. PCT/CN2013/075723, filed May 16, 2013, which claims the benefit of Chinese Patent Application No. 201210180427.5, filed Jun. 4, 2012, and Chinese Patent Application No. 201220259100.2, filed Jun. 4, 2012, each of which is incorporated by reference herein in its entirety.

### FIELD

The present disclosure relates to the field of wireless charging, and more particularly to a transmitting device, a wireless charging system comprising the transmitting device, and a method for controlling a charging process of the wireless charging system.

### BACKGROUND

Currently, the application range of a mobile terminal has become wider and wider, and the mobile terminal has powerful functions and excellent facility. For example, mobile phones, IPADs, and rechargeable 3D glasses provide a wealth of entertainment, such as watching television, surfing the Internet and singing. During the use of the mobile terminal, due to the limited capacity of a battery, the power of the battery will eventually drain. For example, the batteries of mobile phones with the Android system popular with users currently need to be frequently charged, so users often carry spare batteries or wired chargers. For many mobile terminals, wired chargers need to be carried to charge the batteries of the mobile terminals, and are relatively cumbersome due to the wires of the wired chargers. Furthermore, since different mobile terminals often require different types of chargers to charge the batteries of the different mobile terminals, many users such as those who travel frequently need to carry chargers for mobile phones, computers, razors and other mobile terminals, and a wide variety of complex wired chargers may bring great inconvenience to the use of consumers.

Therefore, wireless chargers avoiding the use of wires and the complexity of a large number of wired chargers are favored by consumers and have good market prospect. The wireless chargers mainly utilize the electromagnetic induction principle. FIG. 1 is a block diagram of a conventional wireless charging system. As shown in FIG. 1, a wireless charging device is provided with a transmitting coil configured to send out the energy of a power supply, and a mobile terminal to be charged is provided with a receiving coil. Varying electromagnetic field is generated by applying varying current in the transmitting coil and coupled to the receiving coil, and consequently a charging current is generated in the receiving coil. In this way, the mobile terminal is charged wirelessly.

However, it has been found by the inventors that the charging state of a transmitting device of the conventional wireless charging system will be affected by the transmitting device itself and external devices, so that the charging efficiency of the conventional wireless charging system is low. For example, when one transmitting device is applied to various forms of receiving devices, the charging efficiencies of the transmitting device for the receiving devices may be changed when the relative positions between the transmitting device and the receiving devices are changed, and the electric energy transmitted by the transmitting device may be reflected or partly wasted in the form of coil heating. Thus, the energy waste in the conventional wireless charging system is serious, and the charging efficiency of the conventional wireless charging system is generally low.

The statements in this section merely provide background information related to the present disclosure and are not admissions of prior art.

### BRIEF SUMMARY

Embodiments of the present disclosure seek to solve one or more of the problems existing in the prior art to at least some extent, such as the problem of low charging efficiency of conventional wireless charging systems.

According to a first aspect of the present disclosure, a transmitting device is provided. The transmitting device comprises: a transmitting coil configured to transmit an electric energy of the transmitting device; an oscillation and FM (frequency modulation) module configured to generate an LC resonance between the transmitting coil and the oscillation and FM module and to adjust a capacitance of the LC resonance so as to change a resonant frequency of the LC resonance; a first detecting module configured to detect a voltage and a current of the transmitting device; a control module configured to output a control signal to control the resonant frequency of the LC resonance according to a predetermined FM mode, to stabilize a resonant frequency corresponding to a highest charging efficiency according to the voltage and the current of the transmitting device and a voltage and a current of a receiving device, and to control the transmitting coil to transmit the electric energy; a first communicating module configured to communicate with the receiving device wirelessly; and a power module configured to supply a drive power to the transmitting device.

In some embodiments, the control module comprises: a computing unit configured to perform an A/D (analogue-to-digital) conversion for the voltage and the current of the transmitting device and the voltage and the current of the receiving device and to compute the highest charging efficiency according to data obtained after the A/D conversion; a memory unit configured to store the highest charging efficiency and the capacitance corresponding to the highest charging efficiency; and a first single-chip microcomputer (SCM) configured to control the resonant frequency of the LC resonance according to the predetermined FM mode, to control the oscillation and FM module to output a capacitance corresponding to the highest charging efficiency, and to control the transmitting coil to transmit the electric energy.

In some embodiments, the control module is configured to control the drive power and to control the transmitting coil to start or stop transmitting the electric energy.

In some embodiments, in the predetermined FM mode, the resonant frequency is progressively increased from 110 KHZ to 205 KHZ with an increment of 1.1 KHZ to 1.65 KHZ.

In some embodiments, the oscillation and FM module comprises: a capacitor unit configured to provide an adjustable capacitance and to generate the LC resonance with the transmitting coil; an inversion unit configured to convert a DC (direct current) voltage output by the power module into an AC (alternating current) voltage for generating the LC resonance; and a control unit configured to adjust the capacitance of the capacitor unit and to control the inversion unit to convert the DC voltage output by the power module into the AC voltage for generating the LC resonance according to the control signal output by the control module.

In some embodiments, the capacitor unit is a capacitor matrix comprising a plurality of capacitors.

In some embodiments, the control unit comprises: a switch matrix comprising a plurality of first switches and configured to control a corresponding capacitor in the capacitor matrix to be connected to a circuit; a pulse-width modulation subunit configured to supply a pulse signal to the inversion unit according to the control signal output by the control module so as to drive the inversion unit; and a second single-chip microcomputer configured to control the pulse-width modulation subunit to operate and to control each first switch in the switch matrix to switch on or off.

According to a second aspect of the present disclosure, a wireless charging system is provided. The wireless charging system comprises a transmitting device and a receiving device. The transmitting device comprises: a transmitting coil configured to transmit an electric energy of the transmitting device; an oscillation and FM module configured to generate an LC resonance between the transmitting coil and the oscillation and FM module and to adjust a capacitance of the LC resonance so as to change a resonant frequency of the LC resonance; a first detecting module configured to detect a voltage and a current of the transmitting device; a control module configured to output a control signal to control the resonant frequency of the LC resonance according to a predetermined FM mode, to stabilize a resonant frequency corresponding to a highest charging efficiency according to the voltage and the current of the transmitting device and a voltage and a current of a receiving device, and to control the transmitting coil to transmit the electric energy; a first communicating module configured to communicate with the receiving device wirelessly; and a power module configured to supply a drive power to the transmitting device. The receiving device comprises: a receiving coil configured to perform an electromagnetic induction coupling with the transmitting coil in the transmitting device and to receive an AC voltage; a rectifying and communicating module configured to rectify the AC voltage received by the receiving coil into a DC voltage and charge a load, and to communicate with the transmitting device wirelessly; and a second detecting module configured to detect the voltage and the current of the receiving device.

In some embodiments, the transmitting device and/or the receiving device further comprise a temperature detecting module configured to detect a temperature of the transmitting device and/or a temperature of the receiving device, and the transmitting device further comprises a second switch configured to disconnect the oscillation and FM module from the transmitting coil according to a first instruction output by the control module when the temperature of the transmitting device and/or the temperature of the receiving device exceed a predetermined temperature threshold.

In some embodiments, the receiving device further comprises a third switch disposed between the rectifying and communicating module and the receiving coil and configured to disconnect the rectifying and communicating module from the receiving coil according to a second instruction output by the control module when the voltage of the receiving device exceeds a predetermined voltage threshold or the current of the receiving device exceeds a predetermined current threshold.

In some embodiments, a plurality of electrical isolating modules are disposed between the control module and the second switch, between the control module and the third switch, between the control module and the first detecting module, and between the control module and the second detecting module respectively.

In some embodiments, the control module comprises: a computing unit configured to perform an A/D conversion for the voltage and the current of the transmitting device and the voltage and the current of the receiving device and to compute the highest charging efficiency according to data obtained after the A/D conversion; a memory unit configured to store the highest charging efficiency and the capacitance corresponding to the highest charging efficiency; and a first single-chip microcomputer configured to control the resonant frequency of the LC resonance according to the predetermined FM mode, to control the oscillation and FM module to output a capacitance corresponding to the highest charging efficiency, and to control the transmitting coil to transmit the electric energy.

In some embodiments, in the predetermined FM mode, the resonant frequency is progressively increased from 110 KHZ to 205 KHZ with an increment of 1.1 KHZ to 1.65 KHZ.

In some embodiments, the oscillation and FM module comprises: a capacitor unit configured to provide an adjustable capacitance and to generate the LC resonance with the transmitting coil; an inversion unit configured to convert a DC voltage output by the power module into an AC voltage for generating the LC resonance; and a control unit configured to adjust the capacitance of the capacitor unit and to control the inversion unit to convert the DC voltage output by the power module into the AC voltage for generating the LC resonance according to the control signal output by the control module.

In some embodiments, the capacitor unit is a capacitor matrix comprising a plurality of capacitors; and the control unit comprises: a switch matrix comprising a plurality of first switches and configured to control a corresponding capacitor in the capacitor matrix to be connected to a circuit; a pulse-width modulation subunit configured to supply a pulse signal to the inversion unit according to the control signal output by the control module so as to drive the inversion unit; and a second single-chip microcomputer configured to control the pulse-width modulation subunit to operate and to control each first switch in the switch matrix to switch on or off.

According to a third aspect of the present disclosure, a method for controlling a charging process of the wireless charging system according to the second aspect of the present disclosure is provided. The method comprises: S1) starting the charging process with a reference frequency; S2) controlling a capacitance of an LC resonance according to a predetermined FM mode within a predetermined resonant frequency range so as to adjust a resonant frequency of the LC resonance, and detecting a voltage and a current of the transmitting device and a voltage and a current of the receiving device corresponding to the capacitance of the LC resonance; S3) obtaining a highest charging efficiency according to the voltage and the current of the transmitting device and the voltage and the current of the receiving device and an optimal capacitance corresponding to the highest charging efficiency; and S4) outputting the optimal capacitance to stabilize the resonant frequency of the LC resonance.

In some embodiments, controlling a capacitance of an LC resonance according to a predetermined FM mode within a predetermined resonant frequency range so as to adjust a resonant frequency of the LC resonance comprises: adjusting a capacitor matrix to change the capacitance of the LC resonance so as to adjust the resonant frequency of the LC resonance.

In some embodiments, the method further comprises: detecting a temperature of the transmitting device and/or a temperature of the receiving device; and determining whether the temperature of the transmitting device and/or the temperature of the receiving device exceed a predetermined temperature threshold, if yes, stopping the charging process.

In some embodiments, the method further comprises: determining whether the voltage of the receiving device exceeds a predetermined voltage threshold or the current of the receiving device exceeds a predetermined current threshold, if yes, stopping the charging process.

In some embodiments, in the predetermined FM mode, the resonant frequency is progressively increased from 110 KHZ to 205 KHZ with an increment of 1.1 KHZ to 1.65 KHZ.

With the transmitting device and the wireless charging system according to embodiments of the present disclosure, the capacitance of the LC resonance is controlled by the control module so as to change the resonant frequency of the LC resonance, the voltage and the current of the transmitting device are detected by the first detecting module and the voltage and the current of the receiving device are detected by the second detecting module so as to obtain the charging efficiency according to the voltage and the current of the transmitting device and the voltage and the current of the receiving device, and then the highest charging efficiency within a predetermined resonant frequency range and an optimal capacitance corresponding to the highest charging efficiency are obtained by the control module, so that the oscillation and FM module may be stably operated in a state corresponding to the highest charging efficiency so as to enhance the charging efficiency of the wireless charging system significantly.

The above summary of the present disclosure is not intended to describe each disclosed embodiment or every implementation of the present disclosure. The Figures and the detailed description which follow more particularly exemplify illustrative embodiments.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a block diagram of a conventional wireless charging system;

FIG. 2 is a block diagram of a transmitting device according to some embodiments;

FIG. 3 is a block diagram of a wireless charging system according to some embodiments;

FIG. 4 is a schematic diagram of a transmitting device according to some embodiments;

FIG. 5 is a schematic diagram of a receiving device of a wireless charging system according to some embodiments;

FIG. 6 is a schematic diagram illustrating a first detecting module and peripheral devices thereof of a wireless charging system according to some embodiments;

FIG. 7 is a block diagram of an oscillation and FM module of a wireless charging system according to some embodiments;

FIG. 8 is a schematic diagram of an oscillation and FM module of a wireless charging system according to some embodiments; and

FIG. 9 is a flow chart of a method for controlling a charging process of a wireless charging system according to some embodiments.

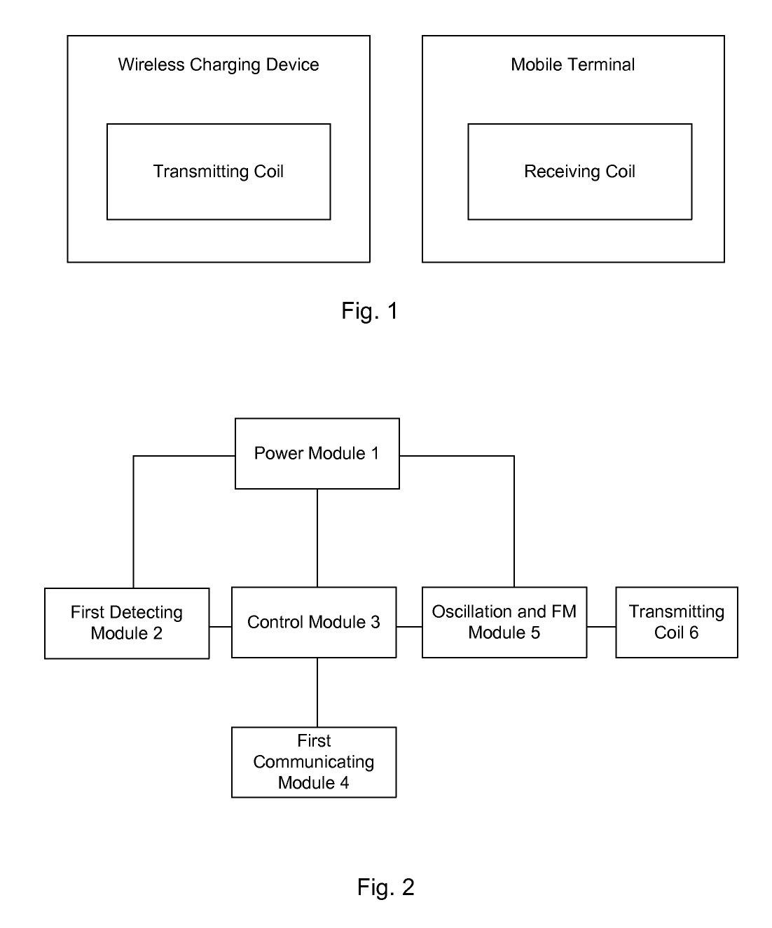

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

Terms concerning attachments, coupling and the like, such as “mounted”, “connected” and “interconnected”, refer to a relationship in which structures are secured or attached to one another either directly or indirectly through intervening structures, as well as both movable or rigid attachments or relationships, unless expressly described otherwise. Further, “connected” and “interconnected” are not restricted to physical or mechanical connections or couplings.

Referring to FIGS. 2-8, according to some embodiments of the present disclosure, a transmitting device is provided. The transmitting device comprises a transmitting coil 6, an oscillation and FM module 5, a first detecting module 2, a control module 3, a first communicating module 4 and a power module 1. The transmitting coil 6 is configured to transmit an electric energy of the transmitting device. The oscillation and FM module 5 is configured to generate an LC resonance between the transmitting coil 6 and the oscillation and FM module 5 and to adjust a capacitance of the LC resonance so as to change a resonant frequency of the LC resonance. The first detecting module 2 is configured to detect a voltage and a current of the transmitting device. The first communicating module 4 is configured to communicate with the receiving device wirelessly. The power module 1 is configured to supply a drive power to the transmitting device. Specifically, the power module 1 is configured to supply a drive power to each module in the transmitting device. The control module 3 is connected between the first detecting module 2 and the oscillation and FM module 5, and configured to output a control signal to control the resonant frequency of the LC resonance according to a predetermined FM mode, to stabilize a resonant frequency corresponding to a highest charging efficiency according to the voltage and the current of the transmitting device and a voltage and a current of a receiving device, and to control the transmitting coil 6 to transmit the electric energy. Specifically, the control module 3 changes the resonant frequency of the LC resonance according to the predetermined FM mode, detects operating state information of the transmitting device and the receiving device, obtains an output power of the transmitting device according to the operating state information of the transmitting device, obtains an input power of the receiving device according to the operating state information of the receiving device, and obtains a charging efficiency according to the output power of the transmitting device and the input power of the receiving device, in which a resonant frequency corresponding to the highest charging efficiency is an optimal resonant frequency. Then, the control module 3 sends the control signal to the oscillation and FM module 5 to adjust the resonant frequency of the LC resonance to the optimal resonant frequency. Thus, the oscillation and FM module 5 is stabilized at the optimal resonant frequency so as to enable the electric energy transmitted by the transmitting device to be received by the receiving device most effectively, thus maintaining the highest charging efficiency of a wireless charging system including the transmitting device and the receiving device.

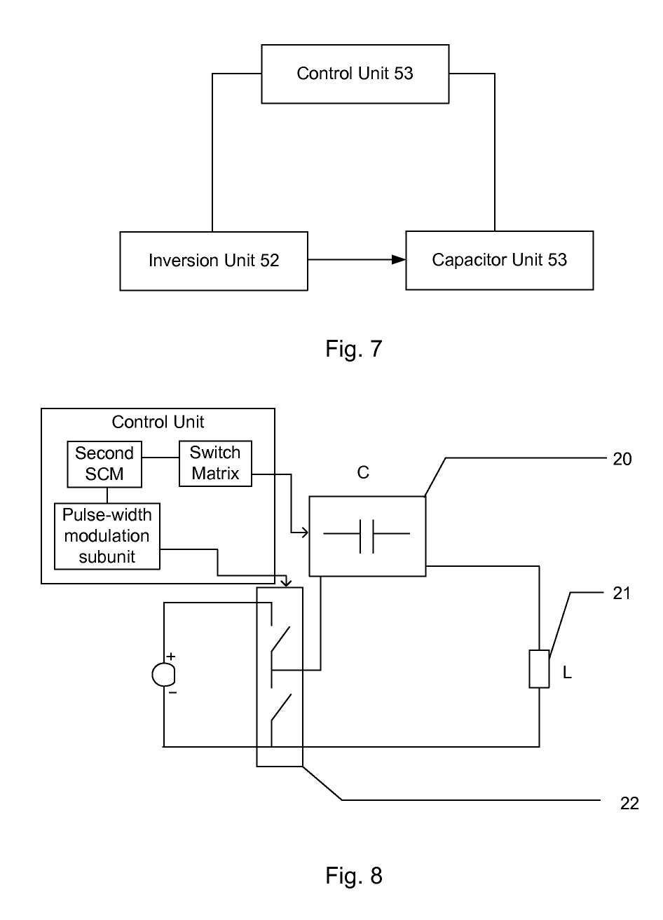

In one embodiment, referring to FIG. 7, the oscillation and FM module 5 comprises a capacitor unit 51, an inversion unit 52 and a control unit 53. The capacitor unit 51 is configured to provide an adjustable capacitance and to generate the LC resonance with the transmitting coil 6. When the capacitance of the capacitor unit 51 is adjusted to a predetermined capacitance threshold, the LC resonance is generated between the capacitor unit 51 and the transmitting coil 6 to enable the transmitting device to operate at the optimal resonant frequency, so that the electric energy of the transmitting device may be transmitted by the transmitting coil 6 efficiently. The inversion unit 52 is configured to convert a DC voltage output by the power module 1 into an AC voltage for generating the LC resonance. The control unit 53 is configured to adjust the capacitance of the capacitor unit 51 and to control the inversion unit 52 to convert the DC voltage output by the power module 1 into the AC voltage for generating the LC resonance according to the control signal output by the control module 3.

In some embodiments, the capacitor unit 51 is a capacitor matrix comprising a plurality of capacitors, and the control unit 53 comprises a switch matrix, a pulse-width modulation subunit and a second single-chip microcomputer. The switch matrix comprises a plurality of first switches corresponding to the plurality of capacitors in the capacitor matrix one to one, and is configured to control a corresponding capacitor in the capacitor matrix to be connected to a circuit. That is, the capacitance of the capacitor unit 51 may be determined according to the capacitor connected to the circuit. The pulse-width modulation subunit is configured to supply a pulse signal to the inversion unit 52 according to the control signal output by the control module 3 so as to drive the inversion unit 52. The second single-chip microcomputer is configured to control the pulse-width modulation subunit to operate and to control each first switch in the switch matrix to switch on or off. The pulse-width modulation subunit and the inversion unit 52 are well known to those skilled in the art, so a detailed description thereof will be omitted here.

The control module 3 comprises a computing unit, a memory unit and a first single-chip microcomputer. The computing unit is configured to perform an A/D conversion for the voltage and the current of the transmitting device and the voltage and the current of the receiving device and to compute the highest charging efficiency according to data obtained after the A/D conversion. Specifically, the computing unit performs an A/D conversion for the voltage and the current of the transmitting device and the voltage and the current of the receiving device, computes the output power of the transmitting device and the input power of the receiving device according to data obtained after the A/D conversion, computes a charging efficiency of the wireless charging system (i.e., a ratio of the input power of the receiving device to the output power of the transmitting device), and computes the highest charging efficiency. The memory unit is configured to store at least the highest charging efficiency and the capacitance corresponding to the highest charging efficiency. The first single-chip microcomputer is configured to control the resonant frequency of the LC resonance according to the predetermined FM mode, to control the oscillation and FM module 5 to output a capacitance corresponding to the highest charging efficiency, and to control the transmitting coil 6 to transmit the electric energy. Specifically, the first single-chip microcomputer adjusts the resonant frequency of the LC resonance, and controls the oscillation and FM module 5 to output the capacitance corresponding to the highest charging efficiency stably so as to stabilize the resonant frequency corresponding to the highest charging efficiency. Meanwhile, the first single-chip microcomputer further controls the transmitting coil 6 to transmit the electric energy. For example, the control module 3 (particularly, the first single-chip microcomputer) is configured to control the drive power and to control the transmitting coil 6 to start or stop transmitting the electric energy. The first single-chip microcomputer may control the power module 1 to convert an AC voltage into a DC voltage, and may control the inversion unit 52 to convert the DC voltage output by the power module 1 into an AC voltage. Preferably, the first single-chip microcomputer may also be connected with an LCD (liquid crystal display) module and a host computer to monitor and control the charging process effectively.

It should be noted that since the AC voltage output by the inversion unit 52 is directly used to generate the LC resonance between the transmitting coil 6 and the capacitor in the capacitor unit 51, only when the resonant frequency is nearest to a frequency (i.e., a transmitting frequency of the transmitting coil 6 or a charging frequency) output by the inversion unit 52, it may be ensured that the charging efficiency is maximized when the transmitting device and the receiving device are in the same state. For example, in practice, the charging frequency must be in a range of 110 KHZ to 205 KHZ as specified by wireless charging standard. Therefore, in the present disclosure, FM (i.e., adjusting a resonant frequency) is performed and the charging efficiency corresponding to the resonant frequency is detected. In this way, the resonant frequency is varied in a range of 110 KHZ to 205 KHZ, and a resonant frequency corresponding to the highest charging efficiency will be found out. Preferably, when the resonant frequency is varied, firstly the resonant frequency is set to 110 KHZ and the charging efficiency corresponding to this resonant frequency is recorded, and then the resonant frequency is progressively increased from 110 KHZ to 205 KHZ with an increment of 1.1 KHZ to 1.65 KHZ. More preferably, the resonant frequency is progressively increased from 110 KHZ to 205 KHZ with an increment of 1.1 KHZ, so as to find out an optimal resonant frequency (i.e., a resonant frequency corresponding to the highest charging efficiency) more quickly and more accurately.

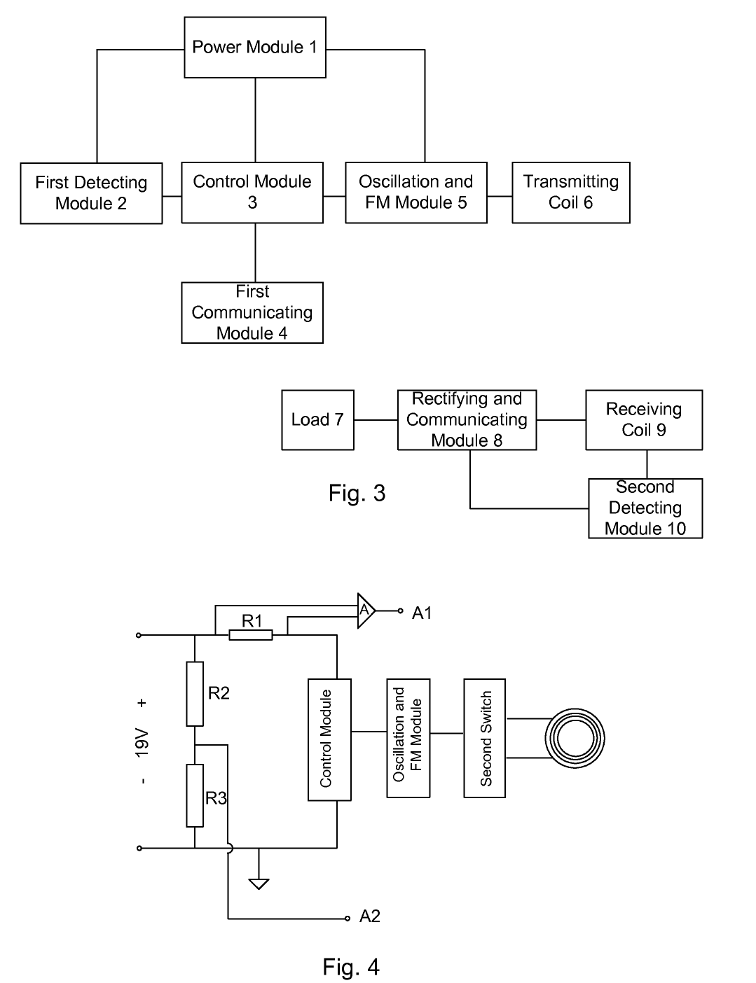

According to an embodiment of the present disclosure, a wireless charging system is also provided. Referring to FIG. 3, the wireless charging system comprises the transmitting device described above and a receiving device. The receiving device comprises a receiving coil 9, a rectifying and communicating module 8 and a second detecting module 10. The receiving coil 9 is configured to perform an electromagnetic induction coupling with the transmitting coil 6 in the transmitting device and to receive an AC voltage. The rectifying and communicating module 8 is configured to rectify the AC voltage received by the receiving coil 9 into a DC voltage and charge a load 7, and to communicate with the transmitting device wirelessly. The second detecting module 10 is configured to detect the voltage and the current of the receiving device. It should be noted that the second detecting module 10 may be mounted on the receiving coil 9 or the load 7. Similarly, the first detecting module 2 may be mounted on the transmitting coil 6 or the power module 1. Since the power output by the power module 1 is partly wasted and then transferred to the transmitting coil 6 and the electric energy received by the receiving coil 9 is partly wasted and then transferred to the load 7, the charging efficiency of the wireless charging system may be computed more accurately when the first detecting module 2 and the second detecting module 10 are mounted on the power module 1 and the load 7 respectively. The power module 1 supplies power to each module in the transmitting device. For example, the power module 1 supplies DC drive voltages to the first single-chip microcomputer, the second single-chip microcomputer and the first detecting module 2 respectively. The drive voltages required by individual modules are different. The power module 1 comprises a conversion unit for converting mains supply of 220V or other powers into a DC power.

Preferably, the wireless charging system further comprises modules for protecting the charging process. For example, the transmitting device and/or the receiving device further comprise a temperature detecting module configured to detect a temperature of the transmitting device and/or a temperature of the receiving device, and the transmitting device further comprises a second switch configured to disconnect the oscillation and FM module 5 from the transmitting coil 6 according to a first instruction output by the control module 3 when the temperature of the transmitting device and/or the temperature of the receiving device exceed a predetermined temperature threshold. The temperature detecting module may be a commonly used element such as a temperature sensor. The second switch is normally closed, and the control module 3 compares the temperature of the transmitting device and/or the temperature of the receiving device with the predetermined temperature threshold in the first single-chip microcomputer, and outputs the first instruction to switch off the second switch when the temperature of the transmitting device and/or the temperature of the receiving device exceed the predetermined temperature threshold so as to disconnect the oscillation and FM module 5 from the transmitting coil 6. The receiving device further comprises a third switch disposed between the rectifying and communicating module 8 and the receiving coil 9 and configured to disconnect the rectifying and communicating module 8 from the receiving coil 9 according to a second instruction output by the control module 3 when the voltage of the receiving device exceeds a predetermined voltage threshold or the current of the receiving device exceeds a predetermined current threshold. Similarly, when the voltage of the receiving device exceeds a predetermined voltage threshold or the current of the receiving device exceeds a predetermined current threshold (i.e., over-charging), the control module 3 outputs the second instruction to switch off the third switch. The second switch and the third switch may be used to stop the charging process so as to protect the charging process, and consequently it would be appreciated that the mounting position of the second switch and the third switch is not limited to this. Preferably, a plurality of electrical isolating modules are disposed between the control module 3 and the second switch, between the control module 3 and the third switch, between the control module 3 and the first detecting module 2, and between the control module 3 and the second detecting module 10 respectively, so as to protect the charging process. The second switch, the third switch and the electrical isolating modules are commonly used in the art and well known to those skilled in the art, so a detailed description thereof will be omitted here.

According to an embodiment of the present disclosure, a method for controlling a charging process of the wireless charging system described above is also provided. The method comprises the following steps.

S1) the charging process is started with a reference frequency.

S2) a capacitance of an LC resonance is controlled according to a predetermined FM mode within a predetermined resonant frequency range so as to adjust a resonant frequency of the LC resonance, and a voltage and a current of the transmitting device and a voltage and a current of the receiving device corresponding to the capacitance of the LC resonance are detected. The expression “within a predetermined resonant frequency range” means that in one FM and detecting cycle, the charging frequency must be in a range of 110 KHZ to 205 KHZ as specified by wireless charging standard. In other words, the resonant frequency is varied from 110 KHZ to 205 KHZ with a predetermined increment.

S3) a highest charging efficiency according to the voltage and the current of the transmitting device and the voltage and the current of the receiving device and an optimal capacitance corresponding to the highest charging efficiency are obtained.

S4) the optimal capacitance is output to stabilize the resonant frequency of the LC resonance.

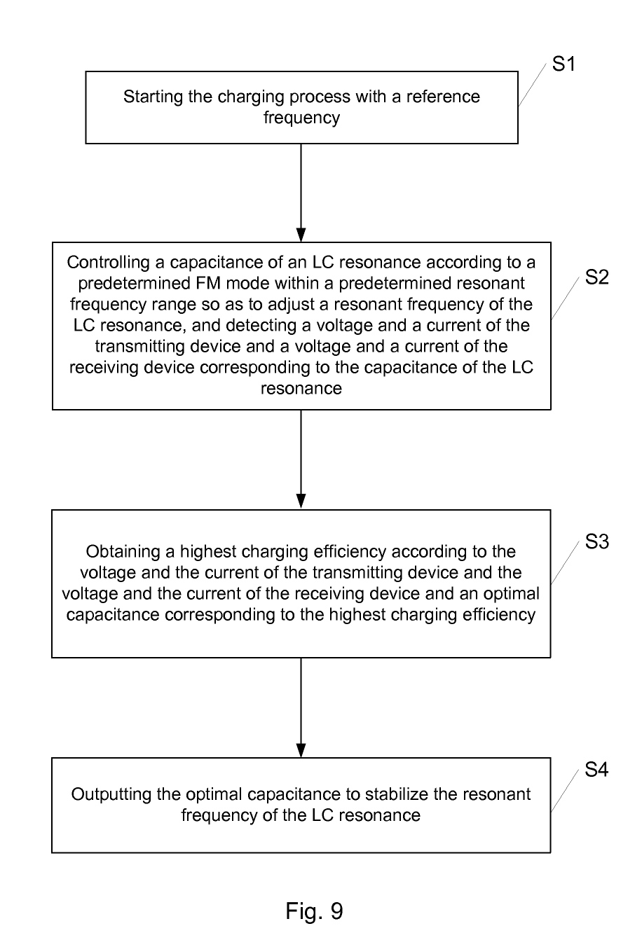

The method for controlling the charging process of the wireless charging system according to an embodiment of the present disclosure will be described in detail with reference to FIG. 9. In this embodiment, in the predetermined FM mode, the resonant frequency is progressively increased from 110 KHZ to 205 KHZ with an increment of 1.1 KHZ to 1.65 KHZ. The particular method for controlling the charging process is as follows. Firstly, by changing the capacitance of the LC resonance, the charging process is started when the resonant frequency is 110 KHZ (i.e., the reference frequency set by a program in the control module 3). Then, the voltage and the current of the transmitting device and the voltage and the current of the receiving device corresponding to the reference frequency (i.e., 110 KHZ) are detected, and the capacitance of the LC resonance is adjusted so as to vary the resonant frequency of the LC resonance from 110 KHZ to 115 KHZ, and the voltage and the current of the transmitting device and the voltage and the current of the receiving device corresponding to the resonant frequency of 115 KHZ are recorded. Thereafter, the resonant frequency is adjusted to be 120 KHZ and 125 KHZ respectively, and the resonant frequency is varied with this increment and the charging state (i.e., the voltage and the current of the transmitting device and the voltage and the current of the receiving device) corresponding to the resonant frequency is recorded, until the resonant frequency is adjusted to be 205 KHZ so as to complete one FM and detecting cycle. Subsequently, the highest charging efficiency according to the voltage and the current of the transmitting device and the voltage and the current of the receiving device and the optimal capacitance corresponding to the highest charging efficiency are obtained. Finally, the optimal capacitance corresponding to the highest charging efficiency is output stably so as to enable the wireless charging system to be in an operating state corresponding to the highest charging efficiency stably.

The inductance of the transmitting coil 6 will change with the environment, for example, when the receiving device is at a far distance to the transmitting device, direct coupling between the receiving coil 9 and the transmitting coil 6 will make the inductance L of the transmitting coil 6 adjusted slightly. Therefore, preferably, FM is performed by adjusting the capacitor matrix to change the capacitance of the LC resonance so as to change the resonant frequency of the LC resonance, thus reaching the optimal charging state more accurately.

In one embodiment, the method further comprises: detecting a temperature of the transmitting device and/or a temperature of the receiving device; and determining whether the temperature of the transmitting device and/or the temperature of the receiving device exceed a predetermined temperature threshold (i.e., over-temperature), if yes, stopping the charging process. For example, when the temperature of the transmitting device and/or the temperature of the receiving device acquired by the control module 3 exceed the predetermined temperature threshold, the control module 3 sends a first instruction to switch off the second switch. Preferably, the method further comprises: determining whether the voltage of the receiving device exceeds a predetermined voltage threshold or the current of the receiving device exceeds a predetermined current threshold (i.e., over-charging), if yes, stopping the charging process. For example, when the voltage of the receiving device exceeds the predetermined voltage threshold or the current of the receiving device exceeds the predetermined current threshold, the control module 3 outputs a second instruction to switch off the third switch so as to stop the charging process.

In conjunction with the embodiments shown in FIGS. 2-8, the operating principle of the transmitting device and the wireless charging system according to embodiments of the present disclosure will be described below in detail.

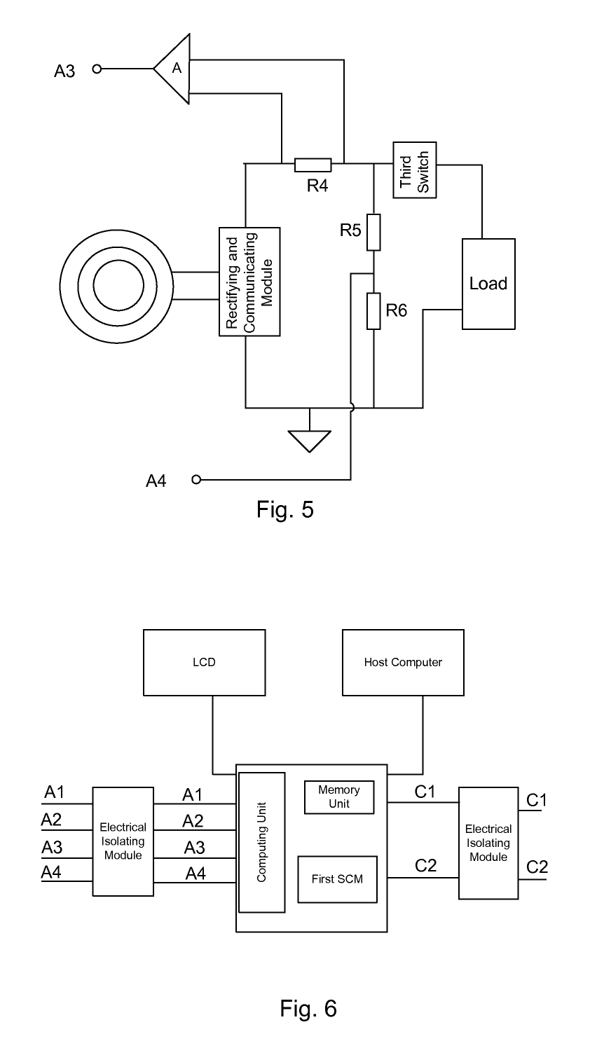

As shown in FIG. 4, the first detecting module 2 comprises a current monitoring circuit consisting of a current detecting resistor R1 and a differential amplifying subcircuit, and a voltage monitoring circuit mainly comprising a divider network formed by divider resistors R2, R3. An output end A of the differential amplifying subcircuit is connected with a port A1 of an AD input end of the first single-chip microcomputer via an electrical isolating module, and the voltage detected by the voltage monitoring circuit is output to a port A2 of the AD input end of the first single-chip microcomputer by an electrical isolating module. In this way, mutual interference between the divider network and a control network may be prevented so as to obtain a stable voltage and a stable current of the transmitting device, and the output power of the transmitting device may be obtained according to the voltage and the current of the transmitting device. Similarly, as shown in FIG. 5, the second detecting module 10 comprises a current monitoring circuit consisting of a current detecting resistor R4 and a differential amplifying subcircuit for detecting the current of the receiving device, and a voltage monitoring circuit mainly comprising a divider network formed by divider resistors R5, R6. An output end A of the differential amplifying subcircuit is connected with a port A3 of the AD input end of the first single-chip microcomputer via an electrical isolating module, the voltage obtained by voltage dividing is output to a port A4 of the AD input end of the first single-chip microcomputer by the electrical isolating module, and the input power of the receiving device may be obtain according to the voltage and the current of the receiving device detected. The variation in the charging process of the wireless charging system may be monitored according to the variation in the output power of the transmitting device and the input power of the receiving device.

Specifically, a strategy for controlling the charging process of the transmitting device is as follows. The resonant frequency is varied from 110 KHZ to 205 KHZ. Specifically, the resonant frequency is progressively increased from 110 KHZ to 175 KHZ with an increment of 1.1 KHZ, and progressively increased from 175 KHZ to 205 KHZ with an increment of 2.2 KHZ, until one FM and detecting cycle is completed. In this way, a capacitance corresponding to the highest charging efficiency is found out and output stably, so as to stabilize the resonant frequency.

With the transmitting device according to embodiments of the present disclosure, the oscillation and FM module is controlled by the control module to change the resonant frequency of the LC resonance, so that the electric energy transmitted by the transmitting device may be utilized effectively so as to enhance the charging efficiency of the wireless charging system.

In conclusion, with the transmitting device and the wireless charging system according to embodiments of the present disclosure, different charging states may be adjusted, and the wireless charging strategy may be monitored in real time and adjusted smartly, so that the wireless charging system may perform charging with the highest charging efficiency. Moreover, the charging efficiency is optimized in an intelligent closed-loop feedback way, thus enhancing the charging efficiency of the entire wireless charging system largely. Furthermore, the over-temperature and over-charging protection is used, thus ensuring the charging safety of the entire wireless charging system.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

That which is claimed:

1. A transmitting device, comprising:
a transmitting coil configured to transmit an electric energy of the transmitting device;
an oscillation and FM module configured to generate an LC resonance between the transmitting coil and the oscillation and FM module and to adjust a capacitance of the LC resonance so as to change a resonant frequency of the LC resonance;
a first detecting module configured to detect a voltage and a current of the transmitting device;
a control module configured to output a control signal to control the resonant frequency of the LC resonance according to a predetermined FM mode, to stabilize a resonant frequency corresponding to a highest charging efficiency according to the voltage and the current of the transmitting device and a voltage and a current of a receiving device, and to control the transmitting coil to transmit the electric energy;
a first communicating module configured to communicate with the receiving device wirelessly; and
a power module configured to supply a drive power to the transmitting device.

2. The transmitting device according to claim 1, wherein the control module comprises:
a computing unit configured to perform an A/D conversion for the voltage and the current of the transmitting device and the voltage and the current of the receiving device, and configured to compute the highest charging efficiency according to data obtained after the A/D conversion;
a memory unit configured to store the highest charging efficiency and the capacitance corresponding to the highest charging efficiency; and
a first single-chip microcomputer configured to control the resonant frequency of the LC resonance according to the predetermined FM mode, to control the oscillation and FM module to output a capacitance corresponding to the highest charging efficiency, and to control the transmitting coil to transmit the electric energy.

3. The transmitting device according to claim 1, wherein the control module is configured to control the drive power and to control the transmitting coil to start or stop transmitting the electric energy.

4. The transmitting device according to claim 1, wherein in the predetermined FM mode, the resonant frequency is progressively increased from 110 KHZ to 205 KHZ with an increment of 1.1 KHZ to 1.65 KHZ.

5. The transmitting device according to claim 1, wherein the oscillation and FM module comprises:
a capacitor unit configured to provide an adjustable capacitance and to generate the LC resonance with the transmitting coil;
an inversion unit configured to convert a DC voltage output by the power module into an AC voltage for generating the LC resonance; and
a control unit configured to adjust the capacitance of the capacitor unit and to control the inversion unit to convert the DC voltage output by the power module into the AC voltage for generating the LC resonance according to the control signal output by the control module.

6. The transmitting device according to claim 5, wherein the capacitor unit is a capacitor matrix comprising a plurality of capacitors.

7. The transmitting device according to claim 6, wherein the control unit comprises:
a switch matrix comprising a plurality of first switches and configured to control a corresponding capacitor in the capacitor matrix to be connected to a circuit;
a pulse-width modulation subunit configured to supply a pulse signal to the inversion unit according to the control signal output by the control module so as to drive the inversion unit; and
a second single-chip microcomputer configured to control the pulse-width modulation subunit to operate and to control each first switch in the switch matrix to be switched on or off.

8. A wireless charging system, comprising a transmitting device and a receiving device, wherein:
the transmitting device comprises:
a transmitting coil configured to transmit an electric energy of the transmitting device;
an oscillation and FM module configured to generate an LC resonance between the transmitting coil and the oscillation and FM module and to adjust a capacitance of the LC resonance so as to change a resonant frequency of the LC resonance;
a first detecting module configured to detect a voltage and a current of the transmitting device;
a control module configured to output a control signal to control the resonant frequency of the LC resonance according to a predetermined FM mode, to stabilize a resonant frequency corresponding to a highest charging efficiency according to the voltage and the current of the transmitting device and a voltage and a current of a receiving device, and to control the transmitting coil to transmit the electric energy;
a first communicating module configured to communicate with the receiving device wirelessly; and
a power module configured to supply a drive power to the transmitting device; and
the receiving device comprises:
a receiving coil configured to perform an electromagnetic induction coupling with the transmitting coil in the transmitting device and to receive an AC voltage;
a rectifying and communicating module configured to rectify the AC voltage received by the receiving coil into a DC voltage and charge a load, and to communicate with the transmitting device wirelessly; and
a second detecting module configured to detect the voltage and the current of the receiving device.

9. The wireless charging system according to claim 8, wherein at least one of the transmitting device or the receiving device further comprises a temperature detecting module configured to detect a temperature of the at least one of the transmitting device or the receiving device, and the transmitting device further comprises a second switch configured to disconnect the oscillation and FM module from the transmitting coil according to a first instruction output by the control module when the temperature of the at least one of the transmitting device or the receiving device exceed a predetermined temperature threshold.

10. The wireless charging system according to claim 9, wherein the receiving device further comprises a third switch disposed between the rectifying and communicating module and the receiving coil and configured to disconnect the rectifying and communicating module from the receiving coil according to a second instruction output by the control module when at least one of the voltage of the receiving device exceeds a predetermined voltage threshold or the current of the receiving device exceeds a predetermined current threshold.

11. The wireless charging system according to claim 10, wherein a plurality of electrical isolating modules are disposed between the control module and the second switch, between the control module and the third switch, between the control module and the first detecting module, and between the control module and the second detecting module respectively.

12. The wireless charging system according to claim 8, wherein the control module comprises:
a computing unit configured to perform an A/D conversion for the voltage and the current of the transmitting device and the voltage and the current of the receiving device and to compute the highest charging efficiency according to data obtained after the A/D conversion;
a memory unit configured to store the highest charging efficiency and the capacitance corresponding to the highest charging efficiency; and
a first single-chip microcomputer configured to control the resonant frequency of the LC resonance according to the predetermined FM mode, to control the oscillation and FM module to output a capacitance corresponding to the highest charging efficiency, and to control the transmitting coil to transmit the electric energy.

13. The wireless charging system according to claim 8, wherein in the predetermined FM mode, the resonant frequency is progressively increased from 110 KHZ to 205 KHZ with an increment of 1.1 KHZ to 1.65 KHZ.

14. The wireless charging system according to claim 8, wherein the oscillation and FM module comprises:
a capacitor unit configured to provide an adjustable capacitance and to generate the LC resonance with the transmitting coil;
an inversion unit configured to convert a DC voltage output by the power module into an AC voltage for generating the LC resonance; and
a control unit configured to adjust the capacitance of the capacitor unit and to control the inversion unit to convert the DC voltage output by the power module into the AC voltage for generating the LC resonance according to the control signal output by the control module.

15. The wireless charging system according to claim 8, wherein the capacitor unit is a capacitor matrix comprising a plurality of capacitors; and the control unit comprises:
a switch matrix comprising a plurality of first switches and configured to control a corresponding capacitor in the capacitor matrix to be connected to a circuit;
a pulse-width modulation subunit configured to supply a pulse signal to the inversion unit according to the control signal output by the control module so as to drive the inversion unit; and
a second single-chip microcomputer configured to control the pulse-width modulation subunit to operate and to control each first switch in the switch matrix to switch on or off.

16. A method for controlling a charging process of a wireless charging system, the wireless charging system comprising a transmitting device and a receiving device, the method comprising:
starting the charging process with a reference frequency;
controlling a capacitance of an LC resonance according to a predetermined FM mode within a predetermined resonant frequency range so as to adjust a resonant frequency of the LC resonance, and detecting a voltage and a current of the transmitting device and a voltage and a current of the receiving device corresponding to the capacitance of the LC resonance;
obtaining a highest charging efficiency according to the voltage and the current of the transmitting device and the voltage and the current of the receiving device and an optimal capacitance corresponding to the highest charging efficiency; and
outputting the optimal capacitance to stabilize the resonant frequency of the LC resonance.

17. The method according to claim 16, wherein controlling the capacitance of the LC resonance according to the predetermined FM mode within the predetermined resonant frequency range so as to adjust the resonant frequency of the LC resonance comprises:
adjusting a capacitor matrix to change the capacitance of the LC resonance so as to adjust the resonant frequency of the LC resonance.

18. The method according to claim 16, further comprising:
detecting a temperature of at least one of the transmitting device or the receiving device;
determining whether the temperature of the at least one of the transmitting device or the receiving device exceeds a predetermined temperature threshold; and
in response to determining that the temperature of the at least one of the transmitting device or the receiving device exceeds the predetermined temperature threshold, stopping the charging process.

19. The method according to claim 16, further comprising:
determining whether at least one of the voltage of the receiving device exceeds a predetermined voltage threshold or the current of the receiving device exceeds a predetermined current threshold; and
in response to determining that the at least one of the voltage of the receiving device exceeds the predetermined voltage threshold or the current of the receiving device exceeds the predetermined current threshold, stopping the charging process.

20. The method according to claim 16, wherein in the predetermined FM mode, the resonant frequency is progressively increased from 110 KHZ to 205 KHZ with an increment of 1.1 KHZ to 1.65 KHZ.
